(19) United States
(12) Patent Application Publication
(10) Pub. No.: US 2012/0282132 A1
(43) Pub. Date: Nov. 8, 2012

(54) METAL AND METAL OXIDE STRUCTURES AND PREPARATION THEREOF

(76) Inventors: James J. Watkins, South Hadley, MA (US); Christos Fotios Karanikas, Mechanicville, NY (US); David Reisner, Bristol, CT (US); Xinqing Ma, Willington, CT (US); Jeff Roth, Bolton, CT (US); T. Danny Xiao, Willington, CT (US); Stephen Paul Murphy, Willimantic, CT (US)

(21) Appl. No.: 13/381,727

(22) PCT Filed: Jul. 13, 2010
(86) PCT No.: PCT/US10/41855

§ 371 Date: Jul. 25, 2012

Related U.S. Application Data
(60) Provisional application No. 61/225,474, filed on Jul. 14, 2009.

(51) Int. Cl. C23C 4/06; C23C 4/08; C01B 13/00; C22C 14/00; C22C 18/00; C22C 9/00; C22C 19/03; C22C 5/04; C22C 27/04; C22C 13/00; C22C 27/02; C22C 5/02; C22C 19/07; C22C 28/00; C23C 4/10; B82Y 40/00; B82Y 30/00

(52) U.S. Cl. 420/416; 427/455; 427/453; 427/456; 423/592.1; 420/417; 420/513; 420/469; 420/441; 420/463; 420/430; 420/557; 420/425; 420/507; 420/435; 420/461; 420/462; 420/466; 977/892; 977/700; 977/810; 977/811

(57) ABSTRACT

Methods of the invention allow rapid production of high-porous, large-surface-area nanostructured metal and/or metal oxide at attractive low cost applicable to a wide variety of commercial applications such as sensors, catalysts and photovoltaics.

### PRIORITY CLAIMS

This application claims the benefit of priority from U.S. Provisional Application Ser. No. 61/225,474, filed Jul. 14, 2009, the entire content of which is incorporated herein by reference for all purposes.

### GOVERNMENT RIGHTS

The United States Government has certain rights to the invention pursuant to Grant Nos. CMMI-0531171 and CBET-0529034 from the National Science Foundation to the University of Massachusetts.

### FIELD OF THE INVENTION

The invention relates to methods and systems for producing metal oxide structures. More particularly, the invention relates to dendritic metal oxide nanostructures that possess desirable physical, chemical, optical and/or electrical properties.

### BACKGROUND OF THE INVENTION

Various methods have been attempted and developed to deposit porous metal oxide films on a substrate surface. These include sol-gel, direct deposition from aqueous solutions, sputtering, molecular self-assembly, ultrasonic pyrolysis, and hydrothermal crystallization (see, e.g., Tesfamichael, et al. Applied Surface Science, 253, 4853-4859 (2007): PCT Appl. Pub. No. WO/2006/126894; US Pat. Appl. Pub. No. 20070281419; US Pat. Appl. Pub. No. 20070049047; US Pat. Appl. Pub. No. 20060014028; US Pat. Appl. Pub. No. 20050279986; US Pat. Appl. Pub. No. 20030118743; U.S. Pat. No. 6,723,388; U.S. Pat. No. 6,952,436; U.S. Pat. No. 4,970,093; Chen, et al. J. Am. Ceram. Soc., 1, 865-872 (2008); US Pat. Appl. Pub. No. 20080072790; U.S. Pat. No. 7,112,758; U.S. Pat. No. 5,171,113; Jessop et al. Chem. Rev. 2007, 107, 2666-2694; Eckert et al. J. Phys. Chem. B 2004, 108, 18108-18118.) Many of these methods, however, suffer the problems of multiple/complex processing steps, long processing time and/or high production costs.

Metal oxide films, for example titanium dioxide (TiO₂), are used in semiconductor materials. Four natural polymorphs of TiO₂ are known to date: anatase, rutile, brooktie, and TiO₂(B). Anatase has a single-phase, crystalline, tetragonal structure. Rutile has a tetragonal structure, but comprises both an amorphous and a crystalline structure. Brooktie has an orthorhombic structure, and TiO₂(B) has a monoclinic structure.

Metal oxide materials are also useful in sensors. Gas sensors, for example, are typically fabricated as sintered porous pellets, or thick films, in which the resistance of the material depends largely on gas adsorption. Both n-type and p-type semiconductors may be used in gas sensors, but n-type are generally preferred because a resistance decrease with concentration is preferable over a resistance increase. In stoichiometric n-type oxides, carbon monoxide (CO) can inject electrons into the conduction band, which results in an increase in the conductivity of the material. The CO interacts directly with the oxide rather than adsorbed oxygen.

In the solar energy fields, for example, the challenges so far have been to tap into the renewable energy source in an efficient and cost-effective way. A solar cell includes a semiconductor that converts light photons into electricity. Solar cells are made by joining p-type and n-type semiconducting materials. The positive and negative ions within the semiconductor provide the environment necessary for an electrical current to move through a solar cell. A solar cell photogenerates charge carriers (electrons and holes) in a light-absorbing material and separates the charge carriers. A solar cell separates the charge carriers to a conductive contact that transmits the electricity. High efficiency solar cells such as crystalline silicon, amorphous silicon, and thin film solar cells such as CuInSe₂ and CdTe all face high production cost issues, while low cost organic-based PV devices face low efficiency and low long-term stability problems.

There is an unmet need for improved/novel materials and methods for producing desirable nanostructures of materials such as metal oxides.

### SUMMARY OF THE INVENTION

The invention is based in part on the discovery and development of novel metal oxide nanostructures and methods for producing the same. Particularly, the method allows direct spray on of crystalline, high-porous, large-surface-area nanostructured metal and/or metal oxide films at attractive low cost, applicable to a wide variety of commercial applications such as sensors, catalysts and photovoltaics.

The invention disclosed herein includes a unique plasma-enhanced process of rapid expansion of supercritical solutions that uses both plasma spray technology and the rapid expansion of supercritical solution. An embodiment of the novel process can be used in rapid production to deposit a variety of metals and/or metal oxides, specifically; titanium oxide and zinc oxide. For instance, titanium (IV) isopropoxide (Ttip) may be used in to deposit highly porous dendritic, with cylindrical macro scale, polycrystalline rutile titania films, consisting of agglomerated sub 100 nm titania crystals. Zinc 2-ethylhexanoate (ZnEO) may be used to deposit highly porous dendritic zinc oxide nanostructures consisting of columnar assemblies of agglomerated zinc oxide particles of approximately 100 nm in size. These high surface area films are useful in making high efficiency inorganic solar cells that are cost effective and have short fabrication times.

For example, the new process enables high-rate, low-cost production of highly porous nanostructured metal oxide films. This film deposition process takes advantage of the solution precursor plasma spray (SPPS) technology and the synergy when incorporated with the use of compressed gas as a precursor solvent, such as carbon dioxide (CO₂). The metal oxide precursor and the compressed solvent (and optionally organic solvent) are mixed in a high-pressure holding vessel by stirring or vigorous shaking. Subsequent releasing of the compressed mixture results in rapid expansion of the mixture into an ultra fine aerosol mist directed to a plasma spray gun. The delivery of the ultra fine aerosol mist to the substrate surface via the plasma jet leads to the decomposition of metal oxide precursor into metal oxide and the formation of a substantially uniform coating containing open, inter-connected, highly porous networks of metal oxide nanostructures. (Chen, et al. J. Am. Ceram. Soc., 91, 865-872 (2008)).

By using the newly developed metal-oxide-film deposition process, for example, a uniform coating containing highly porous nanostructures of titanium oxide or zinc oxide can be formed on a silicon wafer. When compared to the standard SPPS deposition process without the use of a compressed solvent, where a dense coating of titanium oxide is formed, the methods of the present invention can provide an open porous, inter-connected (dendritic) structure.

In one aspect, the invention generally relates to a method for producing a structure (e.g., a nanostructure) of a metal or metal oxide. The method includes: providing a high-pressure mixture comprising a precursor to a metal or metal oxide and a precursor medium containing a compressible solvent as solvent or solute; causing a rapid expansion of the high-pressure mixture so as to produce an ultra fine aerosol mist of the precursor to the metal or metal oxide and the precursor medium; delivering the ultra fine aerosol mist to a flame jet directed at a substrate; and causing the precursor to the metal or metal oxide to convert into the metal or metal oxide thereby depositing on the substrate a nanostructure comprising the metal or metal oxide.

In a preferred embodiment, the high-pressure mixture is in a supercritical state. The nanostructure prepared by the method may be amorphous or crystalline. In some embodiments, the nanostructure is polycrystalline. The nanostructure is preferably an open, branched, interconnected, dendritic structure.

The metal is selected from, or the metal oxide is the oxide of a metal selected from the group including: for example, Ti, Zn, Zr, Si, Cu, Ni, Pd, W, Sn, Nb, Au, Co, Ir, Rh, Ru, Pt, Ce, Ba, Bi, Fe, Hf, La, Se, Ta, Sr, Sn, V, W, Nd, Yb, Ag, Ge and Y. Organic or inorganic dopants include C, P, N, etc. For example, the TiO₂ nanostructure produced may be polycrystalline rutile. In one embodiment, the precursor solvent may be selected from a class of compressible solvents including CO₂, ethane, propane, and dimethyl ether. (See, e.g., U.S. Pat. No. 5,789,027). In some embodiments the solvent such as NH₃ may react with the precursor to modify the chemical or structural nature of the film. The volume percentage of metal or metal oxide precursor may be from about 99% to about 5% (compared to precursor medium from about 1% to 95%). In some embodiments, the high pressure mixture includes precursors of two or more metal oxides, for example, two or more oxides of the above metals. In some other embodiments, the high pressure mixture includes a metal and metal oxide mixture. In some embodiments, the high pressure mixture includes organic or inorganic doping agents for the films. Organic solvent(s) may be used along with CO₂ for certain applications.

In some embodiments, the high pressure mixture may further include an additive capable of modifying a crystalline habit. Additives known in the art that are useful in modifying crystalline habits to achieve the desired results may be used.

In another aspect, the invention generally relates to a metal or metal oxide nanostructure produced by the process of: providing a high-pressure mixture comprising a precursor to a metal or metal oxide and a precursor medium as solvent or solute; causing a rapid expansion of the high-pressure mixture so as to produce an ultra fine aerosol mist of the precursor to the metal or metal oxide and the precursor medium; delivering the ultra fine aerosol mist to a flame jet directed at a substrate; and causing the precursor to the metal or metal oxide to convert into the metal or metal oxide thereby depositing on the substrate a nanostructure comprising the metal or metal oxide.

In yet another aspect, the invention generally relates to a system for producing a nanostructure of a metal or metal oxide on a substrate surface. The system includes: a high temperature jet source; and an atomizing device directed at the path of a plasma jet from the plasma jet source. The high temperature (e.g., 6,000° C. to 16,000° C.) jet source may include: a gas inlet; a cathode; an anode; and a plasma jet outlet. The atomizing device may include: an atomizing nozzle; and a holding container. The high temperature jet source may be a plasma jet source.

In yet another aspect, the invention generally relates to a method for producing a high-porosity nanostructure of a metal oxide. The method includes delivering an ultra fine aerosol mist of a metal oxide precursor and a precursor solvent to a plasma jet directed at a substrate surface thereby causing the metal oxide precursor to convert into the metal oxide nanostructure on the substrate surface.

In yet another aspect, the invention generally relates to a method for producing a metal oxide thin film. The method includes: providing a high-pressure mixture comprising a precursor to a metal oxide and a precursor medium as solvent or solute; causing a rapid expansion of the high-pressure mixture so as to produce an ultra fine aerosol mist of the precursor to the metal oxide and the precursor medium; delivering the ultra fine aerosol mist to a flame jet directed at a substrate; and causing the precursor to the metal oxide to convert into the metal oxide thereby depositing a thin film of the metal oxide on the substrate.

In yet another aspect, the invention generally relates to a method for producing a structure (e.g., nanostructure) of a material comprising a chemical compound. The method includes: providing a high-pressure mixture comprising a precursor to the chemical compound and a precursor medium; causing a rapid expansion of the high-pressure mixture so as to produce an ultra fine aerosol mist of the precursor to the compound and the precursor medium; delivering the ultra fine aerosol mist to a plasma jet directed at a substrate; causing the precursor to the compound to convert into the compound via a chemical reaction; and depositing a nanostructure comprising the compound on the substrate.

In yet another aspect, the invention generally relates to an article comprising a nanostructure of a material prepared by any of methods disclosed herein.

### BRIEF DESCRIPTION OF THE DRAWINGS

FIG. 1 is a schematic representation of an embodiment of the invention.

FIG. 2 is a schematic representation of an embodiment of the invention.

FIG. 3 shows exemplary chemical structure of titanium(di-isopropoxide) bis(acetylacetonate), tris(2,2,6,6-tetramethyl-3-5-heptanedionato)aluminum. Al(tmhd)3, titanium(IV) 2-ethylhexoxide and zinc 2-ethylhexanoate.

FIG. 4 shows exemplary FE-SEM top-down (top) and cross sectional (bottom) of 10 vol. % Ttip sample.

FIG. 5 shows exemplary FE-SEM top-down (top) and cross sectional (bottom left and right) of 25 vol. % Ttip sample.

FIG. 6 shows exemplary FE-SEM top-down (top) and cross sectional (bottom left and right) of 75 vol. % Ttip sample.

FIG. 7 shows exemplary FE-SEM top-down (top) and cross sectional (bottom) of 100 vol. % Ttip (no CO2) control sample.

FIG. 8 shows exemplary XRD of 75 vol. % Ttip sample.

FIG. 9 shows exemplary XPS sputter depth profile (top) and survey scan (bottom) of 75 vol. % Ttip sample.

FIG. 10 shows exemplary IR temperature profile of a typical Ttip deposition.

FIG. 11 shows exemplary FE-SEM top-down (top) and cross sectional (bottom) of 25 vol. % ZnEO sample.

FIG. 12 shows exemplary FE-SEM top-down (top) and cross sectional (bottom) of 50 vol. % Ttip ZnEO sample.

FIG. 13 shows exemplary FE-SEM top-down (top) and cross sectional (bottom) of 100 vol. % ZnEO control sample.

FIG. 14 shows exemplary XRD of 50 vol. % ZnEO sample.

FIG. 15 shows exemplary XPS sputter depth profile (top) and survey scan (bottom) of 50 vol. % ZnEO sample.

FIG. 16 is a schematic representation of a layered structure comprising TiO₂.

### DETAILED DESCRIPTION OF THE INVENTION

The invention provides novel nanostructured compositions and methods for producing such unique structures for materials such as metals, metal oxides and mixtures thereof. Particularly, the method allows rapid production by direct spray of crystalline, high-porous, large-surface-area nanostructured metal and/or metal oxide films at attractive low cost. The compositions and methods of the invention are applicable to a wide variety of commercial applications such as sensors, catalysts and photovoltaics.

### High Surface Area Nanostructured Oxide Films

High surface area nanostructured oxide films are crucial device elements for next generation energy conversion technologies. While much fundamental work has been conducted to demonstrate feasibility and build prototypes, little progress has been made towards addressing the cost and reliability of efficient, high rate manufacturing processes, for instance in for making layers or films for devices.

The present invention includes a deposition technology useful for producing pure or doped nanofilms. The deposition technology offers well controlled architectures and suitable relationships between deposition conditions, precursor reactivity and film properties. High quality solar cells can be constructed using the compositions and methods of the invention that offer superior properties to baseline devices made with traditional film technologies.

The present invention provides an inexpensive, scalable, spray on route to nanostructured metal oxide films that can significantly reduce the cost of solar cells and H₂ generation. The technology is applicable to various devices, including sensors, batteries, and solar energy (such as dye-sensitized and flexible solar cells). The anticipated benefits/potential commercial applications include robust processing, high quality and performance, and economical affordability for next generation energy conversion devices. The spray on nature of the processes of the invention enables low cost, large area segment of potential applications. The ability to fine tune film structure and crystallinity at the nanoscale offers significant improvements in device performance and efficiency.

For instance, novel nanostructured dendritic oxide films that are useful for solar energy device applications can be made using the invention disclosed herein. Desired thin film structures may be constructed that have superior structural and application property characterizations, as well as process optimization.

### Plasma Spray

Plasma spraying is one of many ways of performing a thermal spray. Thermal spraying is a technique that is used for line-of-sight coatings on objects. The material used for coating is heated by a variety of methods, one of which is plasma. When a plasma jet with a typical temperature of 10⁵ K is utilized for heating of the coating material, the technique is called plasma spraying. The coatings formed are on the order of a few microns thick and are quite dense. Plasma spraying can be used to spray a variety of materials ranging from polymers, metals and ceramics. One method used for feeding the coating material to the system is via solutions. Recently, studies have been undertaken to better understand the mechanism by which the coating is formed. (Gell, et al. Surface and Coating Technology 2004, 177-178, 97-102; Xie, et al. Surface and Coating Technology 2004, 177-178, 103-107; Xie, et al. Surface and Coating Technology 2004, 183. 51-61.) Some examples of deposited materials include TiO₂. ZrO₂—Al₂O₃ and Y₂O₃—ZrO₂. (Chen, et al. J. Am. Chem. Soc. 2008, 91, 865-872; Vasiliev, et al. Acta Materialia 2006, 54, 4913-4920, Xie, et al. Surface and Coating Technology 2004, 177-178, 103-107; Xie, et al. Surface and Coating Technology 2004, 183, 51-61.)

### GAS Expanded Solvents

A new and benign class of liquid solvents is gas-expanded liquids (GXLs). They can offer many advantages for separations, reactions, and advanced materials. GXLs are intermediate in properties between conventional liquids and supercritical fluids both in solvating power and in transport properties. The properties of GXLs are generally tunable by simple pressure variations. GXLs are formed by the dissolution of a gas (e.g., CO₂) in organic liquids. Typically, liquid CO₂ is a poor solvent while typical organic solvents such as acetone and methanol are good solvents, which makes a range of solvation properties readily accessible. As a result, GXLs display a combination of the low-pressure advantages in liquid CO₂ (vs supercritical CO₂) and the co-solvation advantages in supercritical CO₂. At moderate pressures (e.g., 3 to 8 MPa), for example. gaseous CO₂ has considerable solubility in many organic solvents, such as alcohols, ketones. ethers, and esters, which provide favorable polarity, dielectric constant, and gas solubility.

Under rapid expansion, a gas expanded liquid causes a rapid decrease in the solubility of the compressed gas in the liquid. Very fine aerosols can be produced when the expansion is conducted across an orifice. The liquid precursor may be the medium expanded by the compressed fluid and serves as the GXL. In some embodiments, an organic solvent containing the desired precursor or mixture of precursors is expanded by the compressed gas and serves as the GXL.

Rapid expansion of supercritical fluids utilizes the changing solvation power of the solvent to create nanometer sized particles. This technique utilizes the ability of supercritical fluids, as compared to gases, to dissolve relatively large concentrations of material to form a single homogeneous phase. The solution is then expanded across a nozzle, which in itself generates small particles. Additional particle size reduction occurs, due to the pressure drop across the nozzle, from the high pressure supercritical state to atmospheric pressure, which causes the dissolved material to precipitate out of solution via nucleation. The crystallized material encapsulates the supercritical solvent, which returns to a liquid state. This causes the small crystal to break, from the inside out and reduces particle size even further. Finally, additional particle size reductions occur with the velocity and frequency at which the expanding particles collide with one another. The process typically generates particles on the nanometer scale. The solvent is typically a pure supercritical fluid or a supercritical fluid containing a small amount (less than 5%) of a liquid co-solvent.

Methods disclosed herein allow for the deposition of high surface area materials which are formed from highly dendritic metal oxides which in turn allow for fabrication of advanced material devices, such as photovoltaic cells. The resultant films are suited for various applications such as photovoltaics, which benefit from thick and high surface area films of metal oxides.

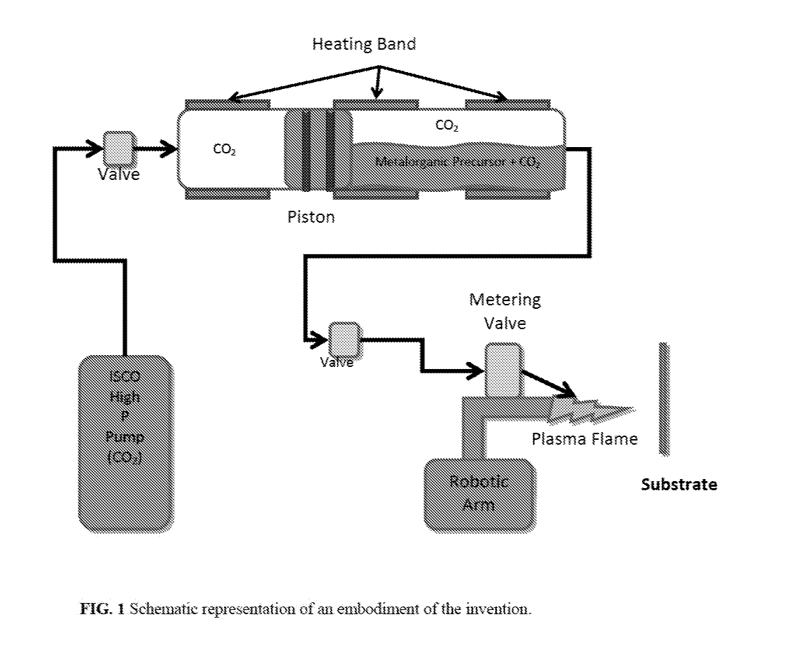

One example of the system is illustrated in FIG. 1, where useable precursors are liquid precursors. In this system, the precursor is loaded into the pressure vessel on the downstream side of the piston. Carbon dioxide is then loaded onto the upstream side of the piston in order to avoid carbon dioxide contact with the precursor while maintaining a constant pressure on the precursor. The carbon dioxide is maintained at pressure using a high pressure ISCO pump. A liquid precursor (or a solution of liquid or solid precursor in an organic solvent) is stored in a high pressure vessel. The high pressure vessel is heated with band heaters to the desired temperature and then a solvent, carbon dioxide, is introduced to the system. Then, a soaking period takes place to allow the compressed fluid to dissolve into the liquid mixture. The vessel is put in line with a high pressure ISCO pump before and a metering valve after which subsequently outputs to the plasma flame. In cases where the compressed gas and the precursor mixture exhibit a high mutual solubility or form a single phase at high pressure, the designation of solute and solvent may be arbitrary. The pressure of the system is maintained by the ISCO pump and the flow rate is controlled by the metering valve. As the precursor mixture with the dissolved solvent reaches the end of the system, it quickly expands at supersonic speeds and instantaneously vaporizes to form a fine mist. This mist then goes directly into a high temperature plasma flame where the mist quickly undergoes a decomposition of the precursor. The desired products are then quickly oxidized and/or crystallized, depending on the precursor, and deposited on a substrate in a pathway directly in front of the plasma spray.

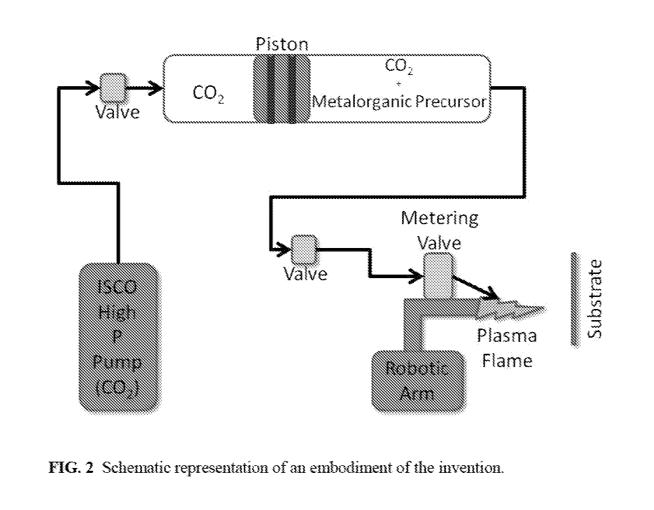

To increase the atomization of the precursor, which decreases particle size, and to help create denser films, liquid carbon dioxide may be introduced to the liquid precursor side in order to allow the carbon dioxide to dissolve into the precursor to produce a high concentration precursor mixture. This allows the high pressure carbon dioxide to rapidly expand across the nozzle and increase atomization of the precursor prior to entering the plasma flame. In order to keep the carbon dioxide in the liquid state, no heating is used for the pressure vessel. Pressure is maintained via a high pressure ISCO pump across a piston in the pressure vessel. The pressure vessel is mixed so that a homogeneous mixture is obtained. From here on, the system (see FIG. 2) is operated in the same manner as discussed above. This process may be used to fabricate films that are highly dendritic and consequently very porous with varying thicknesses (e.g., a few hundred nanometers to multiple microns) simply by adjusting processing parameters.

In one aspect, the invention generally relates to a method for producing a structure (e.g., nanostructure) of a metal or metal oxide. The method includes: providing a high-pressure mixture comprising a precursor to a metal or metal oxide and a precursor medium as solvent or solute: causing a rapid expansion of the high-pressure mixture so as to produce an ultra fine aerosol mist of the precursor to the metal or metal oxide and the precursor medium, delivering the ultra fine aerosol mist to a flame jet directed at a substrate; and causing the precursor to the metal or metal oxide to convert into the metal or metal oxide thereby depositing on the substrate a nanostructure comprising the metal or metal oxide.

In a preferred embodiment, the high-pressure mixture is in a supercritical state. The nanostructure prepared by the method may be amorphous or crystalline. In some embodiments, the nanostructure is polycrystalline.

The properties of the film can be controlled by the selection of precursor and precursor mixtures, the addition of dopants or crystal habit modifiers, the relative concentrations of the precursor, the presence of an organic solvent, the ratio of the compressed solvent to the precursor mixture, the temperature and pressure of the mixture, diameter of the nozzle, the flow rate of the precursor mixture, the substrate temperature and the distance between the substrate and the nozzle, and the application of electrical, magnetic or other fields at the orifice, the substrate or the path between the orifice and the substrate.

The structure, for instance an interconnected structure that exhibits mechanical integrity and electrical or ionic conduction pathways, may have open volume greater than 15%, preferably greater than, for example, about 20%, about 25%, about 30% or about 50%.

The metal oxide is the oxide of a metal selected from the group consisting of: Ti, Zn, Zr, Si, Cu, Ni, Pd, W, Sn, Nb, Au, Co, Ir, Rh, Ru, Pt, Ce, Ba, Bi, Fe, Hf, La, Se, Ta, Sr, Sn, V, W, Nd, Yb, Ag, Ge, and Y, for example. Precursors are chosen so that they yield the desired material composition on the substrate surface. Any reaction yielding the desired material from the precursor can be used. For example, the precursor to TiO₂ may be titanium tetra isopropoxide (Ttip), titanium(diisopropoxide)bis(acetylacetonate), and titanium(diisopropoxide bis(tetramethyl heptane dionate)). The nanostructure produced may be polycrystalline rutile.

Solvents that may be used as supercritical fluids are well known in the art and are sometimes referred to as dense gases (Sonntag et al., Introduction to Thermodynamics, Classical and Statistical, 2nd ed., John Wiley & Sons, 1982, p. 40). At temperatures and pressures above certain values for a particular substance (defined as the critical temperature and critical pressure, respectively), saturated liquid and saturated vapor states are identical and the substance is referred to as a supercritical fluid. Solvents that are supercritical fluids are less viscous than liquid solvents by one to two orders of magnitude. Generally, a supercritical solvent can be composed of a single solvent or a mixture of solvents, including for example, a polar liquid co-solvent such as methanol.

The table below lists certain examples of solvents along with their respective critical properties. These solvents can be used by themselves or in conjunction with other solvents to form the supercritical solvent. The table respectively lists the critical temperature, critical pressure, critical volume, molecular weight, and critical density for each of the solvents.

TABLE 1
Critical Properties of Exemplary Solvents

| | | | | Molecular | |
|---|---|---|---|---|---|
| Solvent | T_{c} (K) | P_{c} (atm) | V_{c} (cm/mol) | Weight | ρ_{c} (g/cm³) |
| CO₂ | 304.2 | 72.8 | 94.0 | 44.01 | 0.47 |
| C₂H₆ | 305.4 | 48.2 | 148 | 30.07 | 0.20 |
| C₃H₈ | 369.8 | 41.9 | 203 | 44.10 | 0.22 |
| n-C₄H₁₀ | 425.2 | 37.5 | 255 | 58.12 | 0.23 |
| n-C₅H₁₂ | 469.6 | 33.3 | 304 | 72.15 | 0.24 |
| CH₃—O—CH₃ | 400 | 53.0 | 178 | 46.07 | 0.26 |
| CH₃CH₂OH | 516.2 | 63.0 | 167 | 46.07 | 0.28 |
| H₂O | 647.3 | 12.8 | 65.0 | 18.02 | 0.33 |
| C₂F₆ | 292.8 | 30.4 | 22.4 | 138.01 | 0.61 |

The volume percentage of metal or metal oxide precursor may be from about 99% to about 5% (compared to precursor medium from about 1% to 95%). In some embodiments. the high pressure mixture includes precursors of two or more metal oxides, for example, two or more oxides of the above metals.

Pressure may be selected depending on the solvent/medium and the actual application, for example, from about 100 psi to about 10,000 psi, e.g. from about 200 psi to about 6,000 psi, from about 400 psi to about 1,000 psi.

In the case of two metal oxides, the metal oxide to metal oxide ratio depends on the applications and may range from about 1:99, to about 10:90, to about 50:50, to about 90:10, and to about 99:1. In some other embodiments, the high pressure mixture includes a metal and metal oxide mixture. The metal to metal oxide ratio depends on the applications and may range from about 1:99, to about 10:90, to about 50:50, to about 90:10, and to about 99:1. Illustrative examples of mixtures of metal and/or metal oxide compositions are listed in Table 2.

TABLE 2
Examples of mixtures of metal and/or metal oxide compositions

1. In the soft magnetic thin film, for example:
Co/SiO₂ (cobalt/silica); Fe/SiO₂ (iron/silica); Fe—Co/SiO₂
(iron-cobalt/silica); Ni/SiO₂ (nickel/silica); Fe—Ni/SiO₂
(iron-nickel/silica); Fe—Co/Al₂O₃ or Fe—Co/ZrO₂
(iron-cobalt/alumina, or iron-cobalt/zirconia)
2. Soft ferrite magnetic thin films, for example:
Fe₃O₄ (iron oxide); NiFe₂O₄ (nickel ferrite); CoFe₂O₄ (cobalt ferrite)
3. Or a combination of the above 1 and 2, for example.
4. Precursors for silica including: siloxane, slanzane, hexmethyldisilane
Iron or iron oxide may be organometallic iron such as iron carbonyl or
other types of iron solutions
Nickel or nickel oxide may be organometallic nickel such as nickel
carbonyl
Cobalt or cobalt oxide may be organometallic cobalt such as cobalt
carbonyl
Organometallic aluminum or zirconium
5. Thin film batteries or sensors, for example:
System such as LiV₂O₅, Li₄Ti₅O₁₂, LiMn₂O₄
For example, aqueous solutions or organometallic solutions of lithium,
manganese, vanadium, and titanium chemicals.

Organic solvent(s) may be used along with supercritical fluid(s) for certain applications. Exemplary organic solvents include: alcohols, acetone, THF, hydrocarbons such as toluene.

Aerosol mist may comprise particles sized from about 25 nm to 1,000 nm, for example, between about 50 nm to about 750 nm, between about 100 nm to about 500 nm.

In another aspect, the invention generally relates to a metal or metal oxide structure (e.g., nanostructure) produced by the process of: providing a high-pressure mixture comprising a precursor to a metal or metal oxide and a precursor medium as solvent or solute; causing a rapid expansion of the high-pressure mixture so as to produce an ultra fine aerosol mist of the precursor to the metal or metal oxide and the precursor medium; delivering the ultra fine aerosol mist to a flame jet directed at a substrate: and causing the precursor to the metal or metal oxide to convert into the metal or metal oxide thereby depositing a nanostructure comprising the metal or metal oxide on the substrate.

In yet another aspect, the invention generally relates to a system for producing a nanostructure of a metal or metal oxide on a substrate surface. The system includes: a high temperature jet source; and an atomizing device directed at the path of a plasma jet from the plasma jet source. The high temperature jet source may include: a gas inlet; a cathode; an anode; and a plasma jet outlet. The atomizing device may include: an atomizing nozzle; and a holding container. The high temperature jet source may be a plasma jet source. The system may be fitted with other components depending on the particular application at hand, for example, a high pressure source, pump, heating source, chiller, etc.

In yet another aspect, the invention generally relates to a method for producing a high-porosity nanostructure of a metal oxide. The method includes delivering an ultra fine aerosol mist of a metal oxide precursor and a precursor solvent to a plasma jet directed at a substrate surface thereby causing the metal oxide precursor to convert into the metal oxide nanostructure on the substrate surface.

In yet another aspect, the invention generally relates to a method for producing a metal or metal oxide thin film. The method includes: providing a high-pressure mixture comprising a precursor to a metal or metal oxide and a precursor medium as solvent or solute; causing a rapid expansion of the high-pressure mixture so as to produce an ultra fine aerosol mist of the precursor to the metal or metal oxide and the precursor medium; delivering the ultra fine aerosol mist to a flame jet directed at a substrate; and causing the precursor to the metal or metal oxide to convert into the metal oxide thereby depositing a thin film of the metal oxide on the substrate.

The metal oxide thin film may be from about 50 nm to about 1,500 μm in thickness, for example, from about 50 nm to about 1,000 μm, from about 100 nm to about 750 μm, from about 1 μm to about 250 μm, or from about 5 μm to about 100 μm.

In yet another aspect, the invention generally relates to a method for producing a nanostructure of a material comprising a chemical compound. The method includes: providing a high-pressure mixture comprising a precursor to the chemical compound and a precursor medium; causing a rapid expansion of the high-pressure mixture so as to produce an ultra fine aerosol mist of the precursor to the compound and the precursor medium: delivering the ultra fine aerosol mist to a plasma jet directed at a substrate; causing the precursor to the compound to convert into the compound via a chemical reaction; and depositing a nanostructure comprising the compound on the substrate.

In yet another aspect, the invention generally relates to an article of manufacture comprising a nanostructure of a material prepared by any of methods disclosed herein.

### EXAMPLES

A direct current Metco 9 MB plasma torch (Sulzer Metco, Westbury, N.Y.) attached to a six axis robotic arm is used as the plasma source. Argon and hydrogen gases are used as the primary and secondary plasma gases, respectively. Precursors are stored in metal-on-metal sealed medium pressure stainless steel tubing (ID= 11/16″, OD=1″, pressure rated to 689 bar) (High Pressure Equipment Company, Erie, Pa.) with custom designed floating pistons utilizing two o-rings for sealing. The system is appropriately outfitted with 1/16″ OD taper sealing stainless steel tubing and needle valves to deliver and control flow. A metering valve is used to control the system flow just prior to the nozzle. The nozzle is a 1/16″ OD piece of stainless steel tubing. Two high power density cartridge heaters (Omega Engineering Inc, Stamford, Conn.) are used to heat the metering valve while the temperature is controlled using a custom built temperature controller with a solid state relay (Omega Engineering Inc, Stamford, Conn.) and microprocessor-based temperature controller, model CN76000 (Omega Engineering Inc, Stamford, Conn.) encased in an aluminum enclosure. A Flir ThermaCam SC 3000 (Flir Systems, Boston, Mass.) is used for infrared imaging of samples. The camera is interfaced with a computer miming ThermaCAM Researcher Pro 2.7 (Flir Systems, Boston, Mass.) to collect and analyze data.

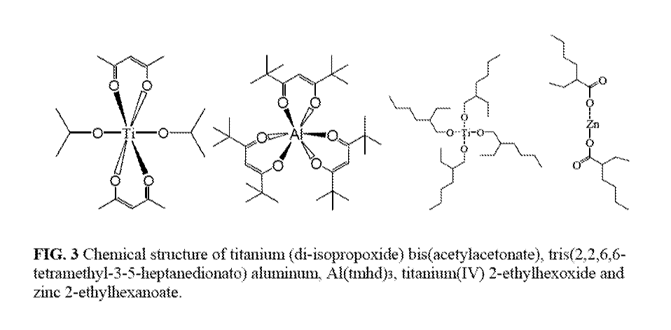

Titanium (di-isopropoxide) bis(acetylacetonate) (75% in isopropanol) [17927-72-9], titanium (di-isopropoxide) bis[BREW], tris(2,2,6,6-tetramethyl-3-5-heptanedionato)aluminum, Al(tmhd)3, [14319-08-5], titanium(IV) isopropoxide [54668-9], titanium(IV) 2-ethylhexoxide [1070-10-6], zinc 2-ethylhexanoate [136-53-8] are used as received without any further purification (Stem Chemicals Inc, Newburyport, Mass.), FIG. 3. Glacial acetic acid [64-19-7] (Fisher Scientific, Pittsburgh, Pa.) is used as received without any further purification. Coleman grade (99.99%) carbon dioxide (Merriam Graves Corp. Charlestown, N.H.) is used as received. Films are deposited on silicon (crystal orientation <100>, 500 nm thermally grown oxide, 1-100 micro-ohm centimeter, 750 micron total thickness) (Novellus, San Jose, Calif.). Additionally, for electrical testing, films are deposited on square inch fluorinated tin oxide glass substrates called Tec 15 (Hartford Glass, Hartford City, Ind.).

Silicon <100> with thermally grown (500 nm) silica and Tec 15, fluorinated tin oxide glass substrates, are mounted to a stainless steel support with copper wires or bolts. The support is a stainless steel I-beam cut in half and drilled with holes used to support the substrates for deposition. The support with substrates is clamped inside of a high throughput ventilation hood. Liquid precursor and any additives are loaded into one side of a high pressure vessel with a floating piston. This is done in a N₂ or Ar glove box if needed. Next, supercritical carbon dioxide (T=60° C., P=103 bar) is loaded from a high pressure ISCO pump into the precursor side of the high pressure vessel. The pressure vessel is not heated and the carbon dioxide returns to a liquid, although still at 103 bar. The vessel is mixed in order to create a homogeneous solution of liquid carbon dioxide dissolved into the liquid precursor: The pressure vessel is then mounted to the six axis robot arm. The precursor side is connected to a metering valve which outputs to a 1/16″ OD stainless steel nozzle. This nozzle sprays directly into the center of the plasma flame. The system is appropriately outfitted with nozzles. The metering valve is heated with two high power density cartridge heaters controlled with a custom built microprocessor, which is controlled by a temperature controller. The temperature is maintained at 70° C. The side of the pressure vessel which does not contain the precursor, called the CO2 side, is connected to the high pressure ISCO pump The ISCO pump operates at constant pressure, P=103 bar. The plasma gun, argon primary and hydrogen secondary gases, is started. A standard movement routine is loaded into the robot arm that the plasma gun is directly attached to. A standard routine pass consists of seven left and seven right motions of the gun each at four mm below the previous motion. The overall vertical distance covered is 64 mm. The overall horizontal distance covered is 300 mm. Flow is controlled with the heated metering valve and read from the flow rate reading on the ISCO pump. For some runs, an IR camera is positioned so as to record temperature profiles of the substrates during deposition. After deposition, samples are allowed ample time to cool.

Highly dendritic metal oxides may be deposited. A concentration study for both titanium oxide and zinc oxide is performed. X-ray photoelectron spectroscopy (XPS), field emission scanning electron microscopy (SEM), x-ray diffraction (XRD) and profilomety are used to determine composition, order, crystalline structure and thickness, respectively.

### Titanium Dioxide

### Concentration

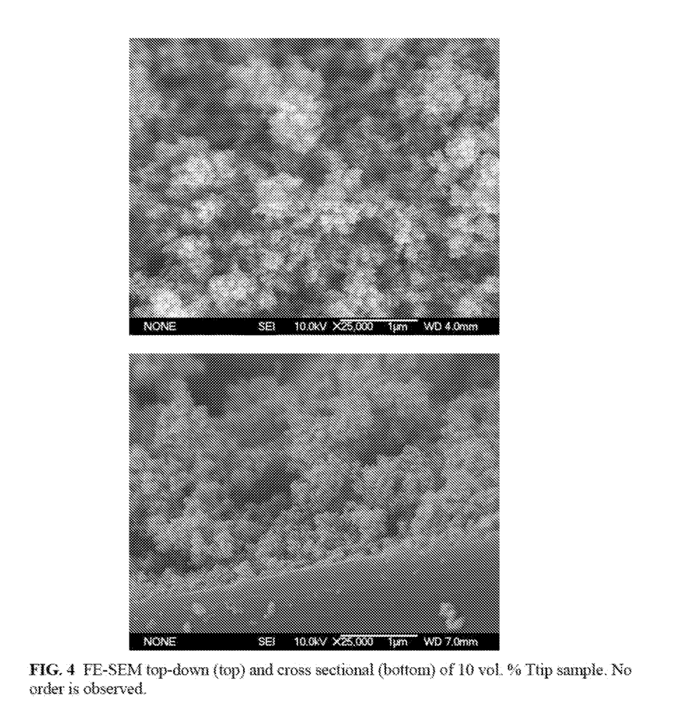

A concentration study of titanium (IV) isopropoxide (Ttip) as the precursor is performed in order to determine the range of concentration at which highly dendritic titania films can be created. The concentration range is about 10% by volume to about 100% by volume, with the remaining volume being liquid carbon dioxide (P=103 bar, T=60° C.). 100% by volume of precursor is used as the control experiment. The experiments are performed at constant pressure, P=103 bar and constant precursor concentration. The plasma torch is maintained at a constant 2″ distance from the substrate surface. At low precursor concentration, 10 vol. % Ttip, no order is seen in the deposition, FIG. 4.

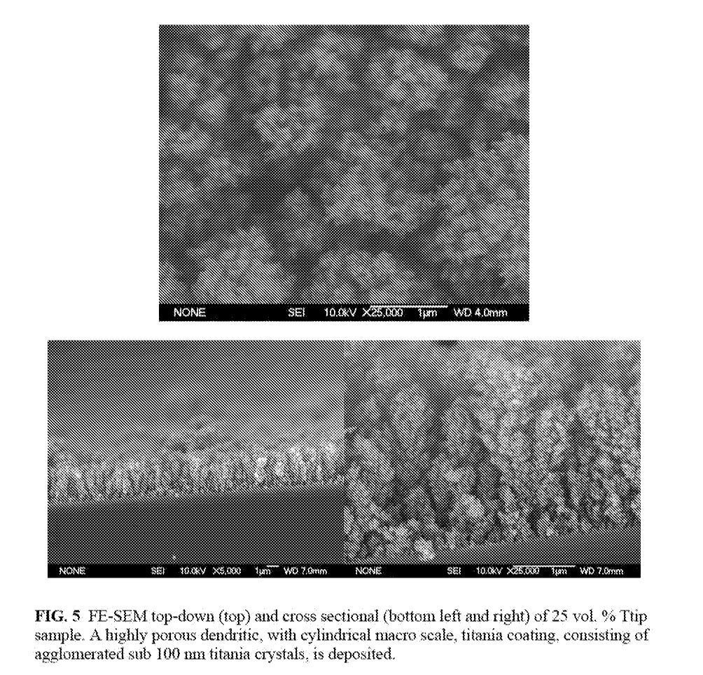

As concentration is increased to 25%, FIG. 5. the cross sectional SEM reveals that a highly porous dendritic, with cylindrical macro scale, polycrystalline rutile titania film, consisting of agglomerated sub 100 nm titania crystals, is deposited.

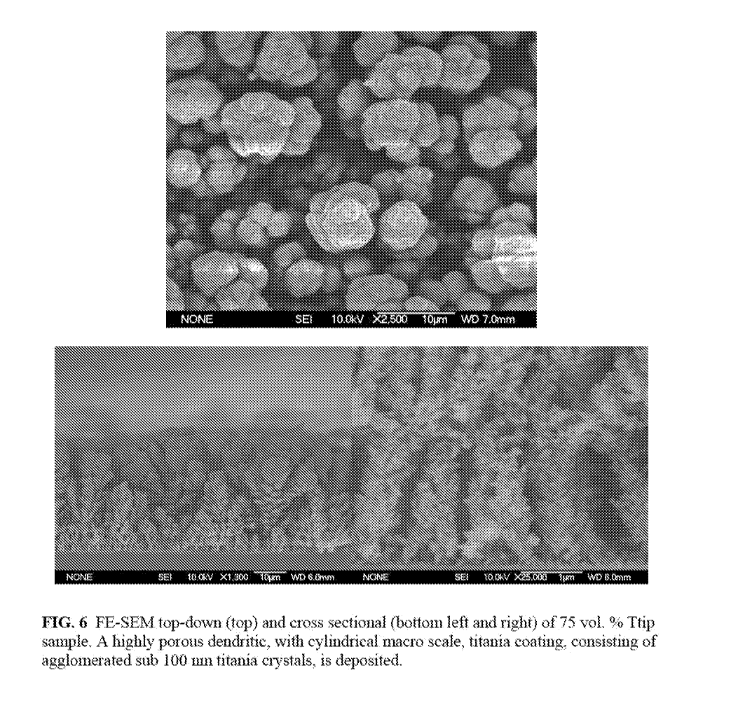

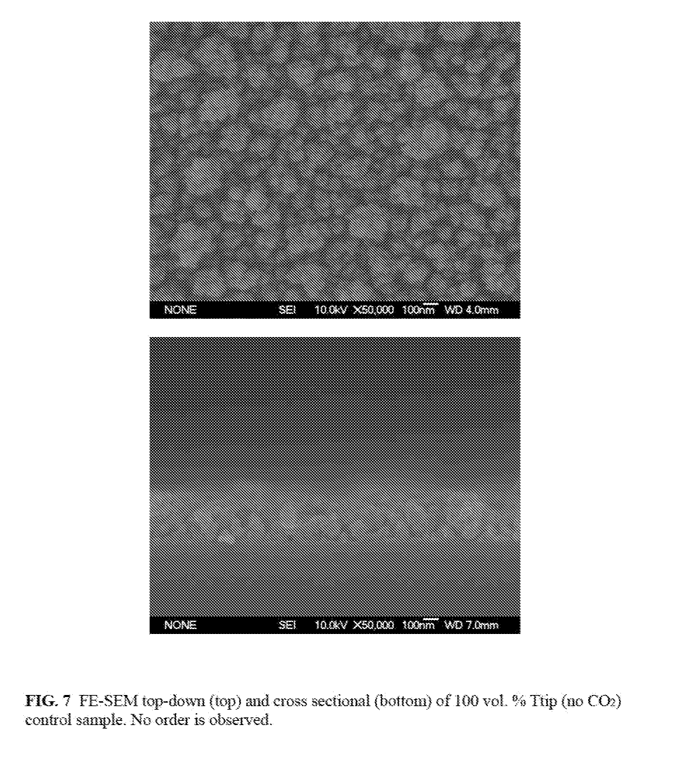

The overall film thickness varied per sample due to the number of passes. Overall, film thickness ranged between about 1 and about 10 microns, as measured by profilometry. At 75% precursor concentration, SEM. FIG. 6, continues to indicate that highly porous dendritic, with cylindrical macro scale, polycrystalline rutile titania film, consisting of agglomerated sub 100 nm titania crystals, is being deposited. Finally, the control experiment of 100% precursor results in a dense film, FIG. 7.

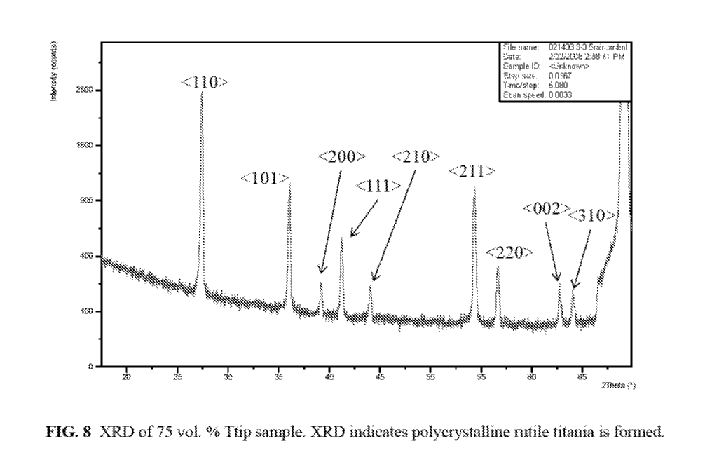

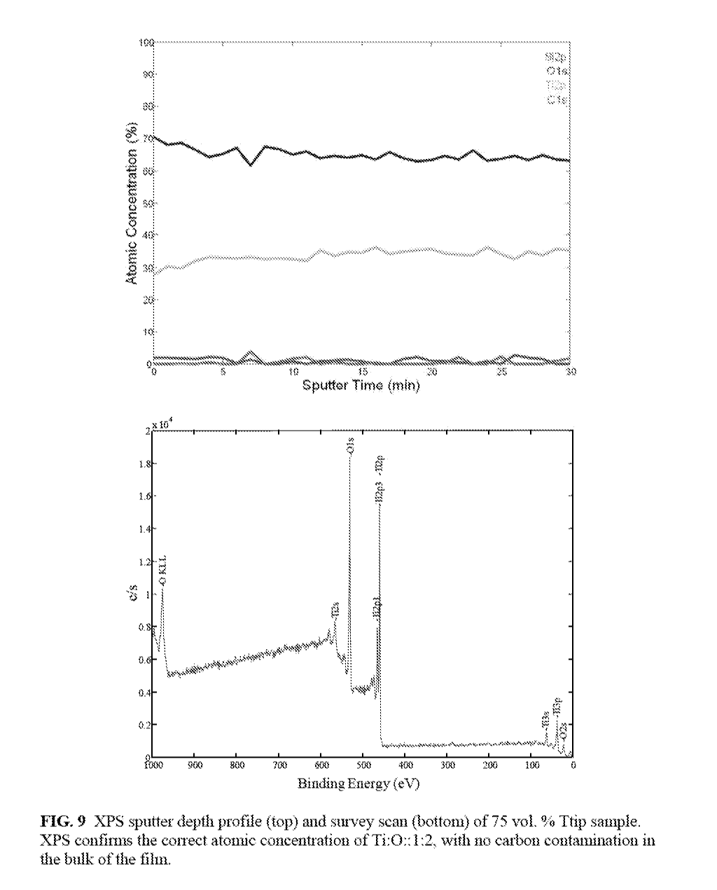

XRD is used to reveal the rutile crystalline form of the titania film, FIG. 8, which is consistent throughout all concentrations. XPS confirms the correct atomic concentration of Ti:O::1:2, with no carbon contamination in the bulk of the film, FIG. 9, which is consistent throughout all concentrations.

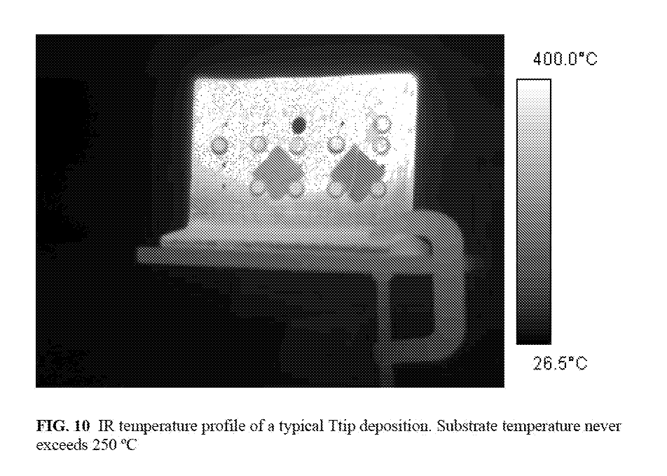

IR data are used to evaluate the temperature of the samples immediately after deposition, FIG. 10. It is found that, typically, after 30 passes, the temperature of the substrate never exceeds 250° C.

### Zinc Oxide

### Concentration

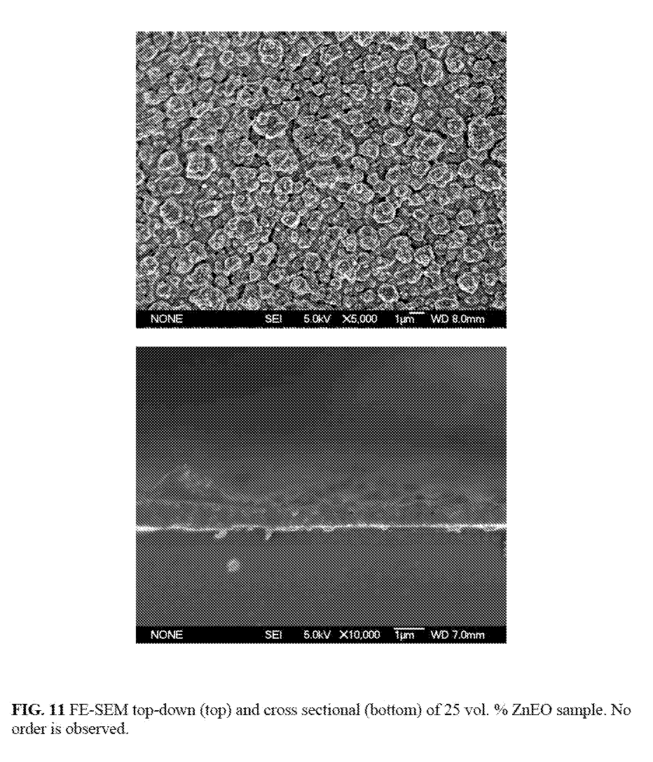

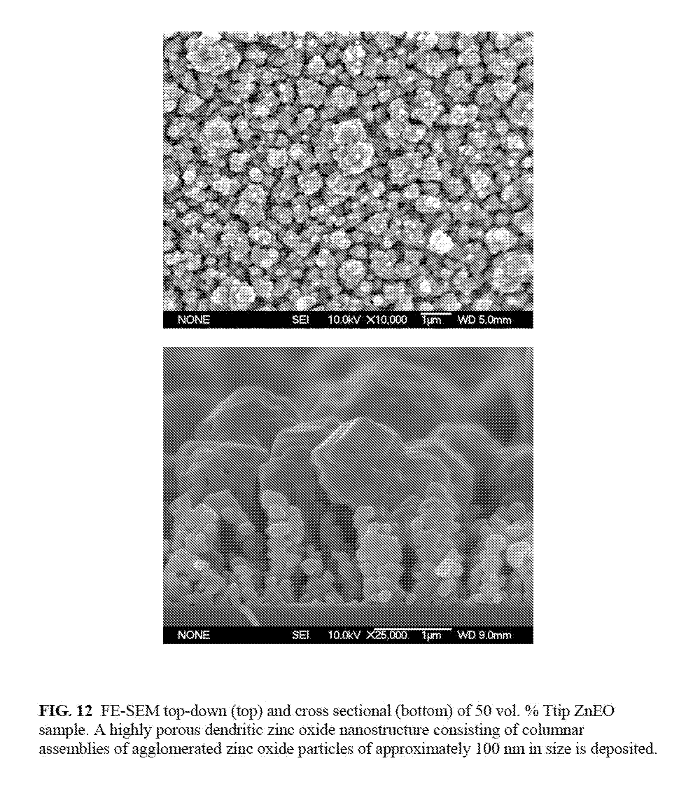

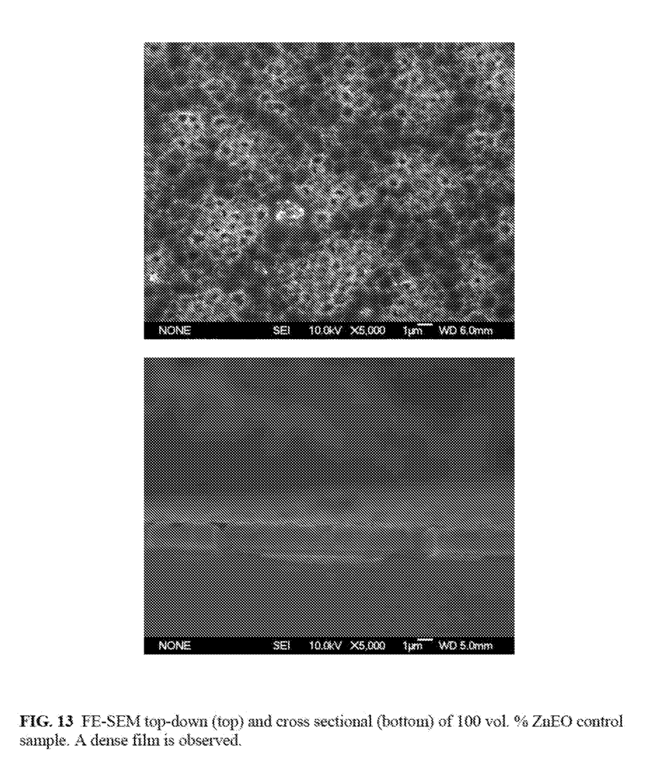

A concentration study of zinc 2-ethylhexonate (ZnEO) as the precursor is performed in order to determine the range of concentration at which highly dendritic Zn oxide films can be created. The concentration range is about 25% by volume to about 100% by volume, with the remaining volume being liquid carbon dioxide (P=103 bar, T=60° C.). 100% by volume of precursor is used as the control experiment. The experiments are performed at constant pressure, P=103 bar and constant precursor concentration. The plasma torch is maintained at a constant 2″ distance from the substrate surface. At low precursor concentration, 25% (volume) ZnEO, no order is seen in the deposited film, FIG. 11. As the concentration is increased to 50% (volume), FIG. 12, the cross sectional SEM reveals that a highly porous dendritic zinc oxide nanostructure consisting of columnar assemblies of agglomerated zinc oxide particles of approximately 100 nm in size is deposited. It is observed that the cylindrical zinc oxide structures are topped with “boulders,” may be due to annealing of the film with subsequent plasma flame passes. The control experiment of 100% precursor results in a dense film, FIG. 13.

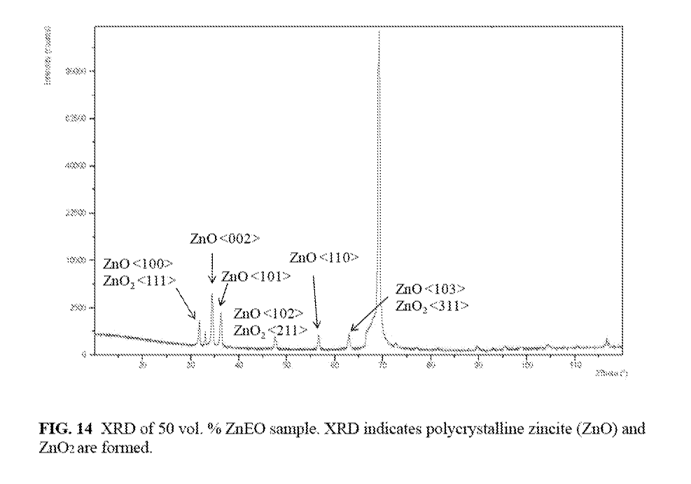

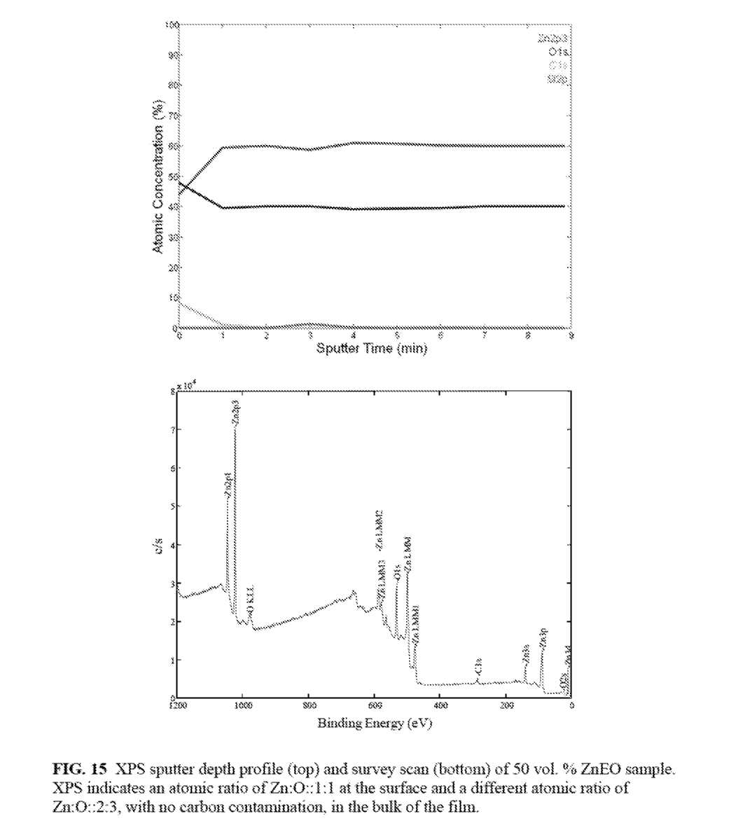

XRD, FIG. 14, indicates that the film consists of polycrystalline zincite (ZnO) and ZnO2. XPS is used to determine the composition of the film. XPS, FIG. 15, indicates an atomic ratio of Zn:O::1:1 at the surface and a different atomic ratio of Zn:O::2:3, with no carbon contamination, in the bulk of the film.

The control experiments are used to validate that through the use of high pressure carbon dioxide, the characteristics of the deposited metal oxide films may be affected. Dense films are observed at 100% (volume) for either Ttip or ZnEO. This is also true at relatively low concentrations for both precursors. The highly dendritic structures occur in the middle of the concentrations range, for example, from about 25% to about 75% or from about 30% to about 80%. This may be due to the vapor-liquid (VL) equilibria ofthe two systems. Typically, when dealing with carbon dioxide and another component whose molecular size varies greatly, a “cigar” shaped VL envelope defines the phase of system in a P-x diagram. (McHugh, et al. Supercritical Fluid Extraction Practice and Principles, Butterworth-Heinemann, 1994.) At both extremes of composition of the heavy component, a single phase persists throughout the range of pressure. However, between these extremes, there exists a region of two phases. When the system is initially injected with CO₂ at high pressure, the system is forced into a single phase. As the solution expands across the nozzle, the two components are forced through this two phase region, resulting in increased atomization of the precursor. It is believed that because of this quick phase change highly dendritic films are deposited in the range of about 25% to about 75% (volume).

The XPS data, FIG. 15, for the ZnEO deposition indicate that a 1:1 ratio of Zn to O is at the surface. This is confirmed with XRD, FIG. 14, which means that zincite (ICSD 00-036-1451) is the mineral form of the zinc oxide at the surface. XPS indicates a Zn to O ratio of 2:3 in the bulk, however, Zn2O3 is a very uncommon form of zinc oxide. XRD also indicates the presence of polycrystalline ZnO2. Given the XPS and XRD data, it is concluded that both ZnO and ZnO2 are in a 1:1 ratio throughout the bulk of the film.

In applying the invention, the size, morphology, and crystal phase of metals and/or metal oxides may be controlled by controlling, for example, flow rate of the precursor, substrate temperature, traveling distance of the precursor in the plasma, precursor concentration, temperature and pressure of the precursor mixture and potentially the addition of stabilizing ligands and or habit modifiers. Further, the nature of the process lends itself to film doping, an important consideration for expanding the absorption edge and performance of the cells. The atomization of the precursor stream to yield a fine aerosol is based on similar principles as those utilized by Union Carbide for the development of a commercial low emissions spray painting process in which CO₂ replaced a significant fraction of the organic solvents used in a spray painting process. The process was implemented successfully and shown to be cost effective in furniture manufacturing lines and in other applications. Processing gases include argon, nitrogen, hydrogen, helium, and mixtures thereof, for example).

A unique advantage of the invention is that a nanostructured, high temperature TiO₂ rutile crystal phase can be readily obtained. Until now, almost all the investigation towards the utilization of nanoporous TiO₂ has been focused on its low temperature phase, the anatase phase. The main reason for the lack of utilization of rutile phase TiO₂ is that the existing processing routes usually produce an amorphous TiO₂ on a transparent conductive glass followed by annealing to obtain the low temperature anatase phase. (Mahajan, et al. J. Phys. D: Appl. Phys., 2008. 41.) The anatase phase transforms to the more stable rutile phase when the temperature exceeds 700° C. (Borkar, et al. J. of Thermal Analysis and Calorimtry, 2004, 78: p. 761-767.) This makes it nearly impossible to obtain rutile phase from the conventional route, since the transparent conductive coating, usually fluorine-doped-tin oxide, cannot withstand such high temperature. There have been articles indicating that anatase is the more active phase of TiO₂ for photocatalysis. (Wold, Chem. Mater., 1993, 5: p. 280-283; Hoffmann, et al. Chem. Rev. 1995. 95: p. 69-96.) However, other studies have shown that the photocurrent-voltage responses of the dye-sensitized rutile and anatase films at one-sun light intensity are very close. (Park. et al. J. Phys. Chem, B, 1999. 103: p. 3308-3314; N.-G. Park, et al. J. Phys. Chem. B, 2000. 104: p. 8989-8994.) Higher photoactivity is also reported on rutile or a mixture of amorphous anatase and rutile phases. (Ohno, et al. J. Phys. Chem. B. 1997. 101: p. 6415-6419; Ohno, et al. J. Catal., 2001. 203: p. 82-86; Nakajima, et al. Chem. Phys. Lett. 2005. 409: p. 81-84.) The inconsistency is believed to be caused by surface area, pore size distribution, crystal size, and synthesis method. (Carp, et al. Prog. Solid State Chem., 2004. 32: p. 33-177.)

The rutile phase of TiO₂ has a narrower band gap than the anatase phase, and this allows the rutile phase to absorb light in a wider light spectrum. (Won, et al. Appl. Phys. A, 2001. 73: p. 595-600.) The relatively larger grain size usually obtained for the rutile phase is likely also to give it advantage in 3D solid-state solar cells, due to the reduced interfacial contact area. A study of the effect of the particle size of anatase TiO₂ used in solid state solar cells indicates that larger particle size TiO₂ particles perform substantially better than smaller particles, opposite of the dye-sensitized liquid electrolyte solar cells. (O'Hayre, et al., Adv. Funct. Mater., 2006. 16: p. 1566-1576.)

TiO₂ and TiO₂-based materials are believed to be the most promising candidates for photoelectrodes in photoelectrochemical cells to produce hydrogen due to its outstanding resistance to corrosion and photocorrosion in aqueous environments. (Nowotny, et al. Int'l J. of Hydrogen Energy, 2007. 32: p. 2609-2629; Holladay, et al. Catalysis Today, 2009. 139: p. 244-260.) The electronic structure of TiO₂ needs to be modified to obtain a narrower band gap, usually through doping with aliovalent ions such as W, Ta, Nb, In, Li, Cr, C, and N. (Karakitsou, J. Phys. Chem. B, 1993. 97: p.1184-1189.)

A single step low cost and high versatility plasma-enhanced rapid expansion of supercritical solution process is, therefore, an extremely attractive approach towards synthesis of nanostructured TiO₂ or doped TiO₂ coating with controlled crystal phase and morphology.

The invention is also suitable for doping. (Yin, J. of Supercritical Fluids, 1998. 13: p. 363-368.) The nanostructure properties may be tuned via control of spray parameters, allowing improved performance of the resulting films for use in photovoltaics and solar water splitting, and scale-up to a large area panel, and substantial cost benefits vs. existing technology.

Plasma spray is one of many ways of performing a thermal spray, in which a liquid precursor or a heated feedstock powdered material is sprayed onto a heated or non-heated surface [61] to form a coating. A plasma jet, whose temperature is usually on the order of 10,000K, is used as the heating element in the plasma spray technique. The coating formed by the plasma spray technique has thicknesses ranges from tens of microns to a few hundred of microns. These coatings are usually dense and have good adhesion to the substrate. A variety of materials ranging from metals, metal oxides, and other ceramics may be applied using the plasma spray technique disclosed herein.

Examples of deposited materials include TiO₂, ZrO₂—Al₂O₃, and Y₂O₃—ZrO₂. (Chen, et al, J. Am. Chem. Soc., 2008. 91; Vasiliev, et al. Acta Materialia, 2006. 54; Xie, et al. Surface and Coating Technology, 2004. 103; Xie, et al. Surface and Coating Technology, 2004. 183.) Plasma has also been used in combination with other thin film deposition techniques such as chemical vapor deposition. (Graciaa, et al. Thin Solid Films 2003. 429: p. 84-90; Holgado, et al. Thin Solid Films, 2001. 389; Borras, et al. Microporous and Mesoporous Materials, 2009. 118: p. 314-324.)

A key to the process is the formation of an ultra-fine precursor solution aerosol produced by the rapid expansion of precursors or precursor solutions diluted with compressed carbon dioxide. It is well blown that organic solvents including light alcohols, acetone, THF and light hydrocarbons are miscible in all proportions with compressed CO₂ above their critical mixture points. (McHugh, et al. Supercritical Fluid Extraction, 2nd ed. 1994, Newton, Mass.: Butterworths-Heinemann.) It is also demonstrated that this is true for certain liquid alkoxides including tetra-ethylorthosilicate. Rapid expansion of these mixtures across an orifice produces a fine aerosol. Since CO₂ gas is no longer miscible with the organic or metalorganic solutions at ambient pressure, supersaturation ratios are enormous and nucleation of fine liquid aerosols results. (Domingo, et al. J. of Supercritical Fluids, 1997. 10: p. 39-55; Matson. et al., Ind. Eng. Chem. Res., 1987. 26: p. 2298-2306.) The employment of supercritical fluid instead of solvent not only makes this process environmentally friendly, it also presents advantages in the final morphology and properties of the aerosol.

Structures and materials having the following characteristics, for example, can be obtained: (1) Nanostructured TiO₂ coating with the particle size in the range of from about 5 nm to about 500 nm through a single step process; (2) TiO₂ crystals with either anatase or rutile phase; (3) TiO₂ structures with controlled morphologies ranging from random networks to dendritic to columnar; and (4) Fe₂O₃ doped TiO₂ nanostructure.

Doped films can be obtained by preparing solutions of TiO₂ precursors such as titanium alkoxides and dopant precursors such as iron acetylacetonate with compressed CO₂. The following experimental parameters of the plasma-enhanced rapid expansion of the supercritical solution are examined: the ratio of the CO₂ to the TiO₂ precursor, the types of precursor, the temperature and pressure of the mixture, diameter of the nozzle, the flow rate of the precursor mixture, and the substrate temperature.

Samples obtained from the plasma-enhanced rapid expansion of supercritical solution are characterized at the Silvio O. Conte National Center for Polymer Research at UMass Amherst. The surface morphology and cross section are characterized with a JEOL JSM 6320 field emission scanning electron microscope (FSEM). The X-ray photoelectron spectroscopy (XPS, Physical Electronics Quantum 2000) are used to detect the composition variation across the entire thickness. X-ray diffraction (XRD, PANanalytical X'Pert) are used to determine the crystal structure of the coating. Atomic force microscope (AFM, DI Dimension-3000 and Dimension-3100 AFM) are used to characterize the surface morphology and profile.

Dye-sensitized solar cells (DSSC) are built on a network of nanometer-sized electron conductors such as TiO₂, ZnO, Nb₂O₅, and WO₃. DSSCs based on TiO₂ have shown good performance. DSSCs are built by forming a mesoporous TiO₂ coating on a fluorine-doped tin oxide (FTO) glass, saturating the surface of TiO₂ with a visible light absorbing dye, and then filling the interconnected nanopores with a liquid electrolyte. Under sun light illumination, the dye molecules attached on the surface of the TiO₂ absorb incident light and inject electrons to the TiO₂ nanoparticles. A single layer of dye molecules, however, can absorb only less than 1% of the incoming light. (O'Regan, Nature, 1991. 353(24): p. 737.) This problem is addressed in the DSSC by using a high surface area mesoporous TiO₂ structure which allows a large amount of dye to be adsorbed in the porous network. A 10 μm TiO₂ film with an average particle size on the order of 20 nm has an internal surface area thousands of times greater than the flat area of an electrode. The injected electrons travel through the interconnected TiO₂ network to the FTO anode. The oxidized dye molecule strips an electron from the liquid electrolyte, and the electrolyte then obtains an electron from the cathode, usually platinum. This completes the electron generation and transport cycle.

In contrast to the silicon type of p-n-junction solar cells, where light absorption and charge transport occurs in the same material, the DSSC separates these functions, and the transport of electrons and holes occurs in different media. Electrons travel in the nanoporous TiO₂ network and holes in the electrolyte. The highest energy conversion efficiencies reported for the DSSC is around 11%. This is a very respectable performance for terrestrial solar cell applications. However, the commercialization of this technology has been somewhat slow, presumably caused by high fabrication costs relative to efficiency and to stability issues associated with the structure of this design.

Important factors affecting the performance of the DSSC are surface area and the contact of TiO₂ particles. High surface area (greater than 50 m²/g) TiO₂ particle/nanotubes/nanorods allow more dye molecules to absorb on the surface of TiO₂ and, therefore, better energy conversion efficiency can be achieved due to the higher light harvesting efficiency. Another important factor is the electron transport through the TiO₂ particles, and this is mainly determined by the contact area between particles and controlled by the particle morphology, crystal phase, and other processing conditions such as annealing process, before annealing and post-annealing treatment.

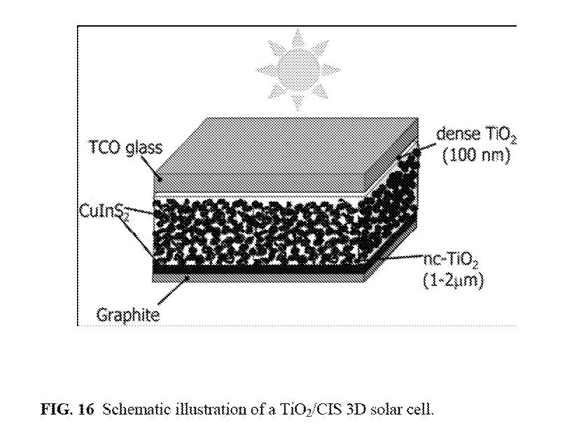

Solid-state solar cells based on interpenetrating TiO₂ nanostructures were first reported about ten years after the publication of DSSC. (O'Hayre, et al. Adv. Funct. Mater., 2006.16: p. 1566-1576; Lenzmann, et al. Thin Solid Films, 2004.451-452: p. 639-643; Nanu, et al. Nano Letters, 2005. 5(9): p. 1716-1719; Nanu, et al. Adv. Mater., 2004.16(5): p. 453-456.) Instead of using a light absorbing dye and a liquid electrolyte as a hole conductor as in DSSC, 3D solid state solar cells utilize semiconductor such as CuInS₂ and CdTe as both light absorber and hole conductor. The solid semiconductor needs to have a band gap in the range of 1.2 to 1.8 eV, so it can absorb the solar light and inject electrons into the TiO₂ phase. The solid state solar cells based on nanostructured TiO₂ network do not require a very high surface area of the TiO₂ network in order to achieve high energy conversion efficiency. On the contrary, a network built with the largest TiO₂ particles exhibited the best energy conversion efficiency, when 9 nm, 50 nm, and 300 nm TiO₂ were compared. A schematic of the 3D TiO₂/CIS solar cell is shown in FIG. 16.

The TiO₂ porous network in the 3D nanocomposite can be made the same way as in the DSSC, except the thickness is reduced from ˜10 μm to 1-2 μm. An extremely thin (100 nm) and full dense TiO₂ layer is also deposited on the FTO glass to prevent contact between the hole conductor and FTO, which would lead to large leakage currents.

3D solid state nanocomposite offers better aging stability compared to the DSSC since it eliminates the less stable organic dye and liquid electrolyte. However, the current energy conversion efficiency of this structure is still lower than the best DSSC, and the highest conversion efficiency is reported to be ˜5%. This might be caused by the harder-to-achieve good contact between the n-type TiO₂ and the p-type semiconductor. (Nanu, et al. Nano Letters, 2005. 5(9): p. 1716-1719)

A first step for building the solid state solar cell is to utilize the mesoporous TiO₂ made from the methods of the invention and infiltrate the pores with a hole conductor such as CuInS₂ and CdSe. Electrochemical deposition is selected as a versatile technique to achieve this infiltration process. Preliminary lab research work indicates that the porosity of TiO₂ mesoporous structure can be effectively filled by electrodepositing a hole conductor such as CdSe or Se.

TiO₂-based coating is attractive for generating hydrogen by photoelectrochemical water splitting since it has excellent corrosion resistance, is low cost and non-toxic, and its band edges are favorably positioned with respect to the hydrogen and oxygen energy levels. (Gratzel, Nature, 2001. 414; Fujishima, Nature, 1972. 238: p. 37-38.) The photoconversion efficiency of the TiO₂ based coating has been limited by its wide band gap which absorbs only UV light. The most effective approaches to obtain modified TiO₂ nanostructures are introducing aliovalent ions Through doping and/or changing the stoichiometry of TiO₂ crystal by annealing the coating in reducing atmosphere. (Nanu, et al. Nano Letters, 2005. 5(9): p. 1716-1719.)

Processes disclosed herein can de designed to produce doped and annealed TiO₂ nanostructure in a single step for the above-mentioned applications.

### Titania (Rutile, Polycrystalline) Film on Silicon Wafer

A highly porous, with cylindrical macro scale, polycrystalline rutile titania film was deposited onto a silicon wafer by the rapid expansion and subsequent plasma reduction of titanium(IV) isopropoxide and liquid carbon dioxide mixture. Polished silicon wafers (crystal orientation <100>, 500 nm thermally grown oxide, 1-100 micro-ohm centimeter, 750 micron total thickness), carbon dioxide and titanium(IV) isoproxide were commercially obtained and used without further modification.

Carbon dioxide (P=1500 psi) was dissolved into titanium(IV) isopropoxide at room temperature (23° C.), in the holding vessel, to produce a 25 vol. % precursor/carbon dioxide solution. The holding vessel was vigorously mixed to ensure a two component single phase mixture. Rapid expansion of the mixture into the path of the plasma gun perpendicular to the substrate surface (as described in the general methods section) produced a uniform coating. Scanning electron microscopy (SEM) of the cross section of the sample revealed a highly porous dendritic Ti02 nanostructure consisting of agglomerated sub-100 nm titania crystals The overall thickness film thickness was of 2.2 microns. X-ray diffraction (XRD) revealed a high purity, polycrystalline rutile titania film. X-ray photoelectron spectroscopy (XPS) also confirms correct atomic concentrations of Ti:O::1:2 with no carbon contamination in the bulk of the film.

### Titania (Rutile, Polycrystalline) Film on a Silicon Wafer

A highly porous, with cylindrical macro scale, polycrystalline rutile titania film was deposited onto a silicon wafer by the rapid expansion and subsequent plasma reduction of titanium(IV) isopropoxide and liquid carbon dioxide mixture. Polished silicon wafers(crystal) orientation <100>, 500 nm thermally grown oxide, 1-100 micro-ohm centimeter, 750 micron total thickness), carbon dioxide and titanium(IV) isoproxide were commercially obtained and used without further modification.

Carbon dioxide (P=1500 psi) was dissolved into titanium(IV) isopropoxide at room temperature (23° C.), in the holding vessel, to produce a 75 vol. % precursor/carbon dioxide solution. The holding vessel was vigorously mixed to ensure a two component single phase mixture. Rapid expansion of the mixture into the path of the plasma gun perpendicular to the substrate surface (as described in the general methods section) produced a uniform coating SEM of the cross section of the sample revealed a highly porous dendritic TiO₂ nanostructure consisting of agglomerated sub 100 nm titania crystals of size and overall thickness of 9.6 microns: XRD revealed a high purity, polycrystalline rutile titania film. XPS also confirms correct atomic concentrations of Ti:O::1:2 with no carbon contamination in the bulk of the film

### Titania (Rutile, Polycrystalline) Film on a Silicon Wafer

A polycrystalline rutile titania film was deposited onto a silicon wafer by the delivery of a pressurized titanium(IV) isopropoxide through a needle valve and subsequent plasma reduction of the precursor. Polished silicon wafers (crystal orientation <100>, 500 nm thermally grown oxide, 1-100 micro-ohm centimeter, 750 micron total thickness) and titanium(IV) isoproxide were commercially obtained and used without further modification. Titanium(IV) isopropoxide at room temperature (23° C.) was loaded into the holding vessel. Plasma reduction of precursor sprayed perpendicular to the substrate surface resulted in a uniform coating. SEM of the cross section of the sample revealed a dense particulate coating of titania lacking an open porous structure. The particles were approximately 100 nm in size and overall thickness of the file was 1.0 microns. XRD revealed a high purity, polycrystalline rutile Titania film. XPS also confirms correct atomic concentrations of Ti:O::1:2 with no carbon contamination in the bulk of the film.

### Zinc Oxide Film on a Silicon Wafer

A highly porous, with cylindrical macro scale, polycrystalline zinc oxide film was deposited onto a silicon wafer by the rapid expansion and subsequent plasma reduction of zinc 2-ethylhexonate and liquid carbon dioxide mixture. Polished silicon wafers (crystal orientation <100>, 500 nm thermally grown oxide, 1-100 micro-ohm centimeter, 7.50 micron total thickness), carbon dioxide and zinc 2-ethylhexonate were commercially obtained and used without further modification.

Carbon dioxide (P=1500 psi) was dissolved into zinc 2-ethylhexonate at room temperature (23° C.), in the holding vessel, to produce a 50 vol. % precursor/carbon dioxide solution. The holding vessel was vigorously mixed to ensure a two component single phase mixture. Rapid expansion and subsequent plasma reduction of the mixture sprayed (as set up and outlined in the general method section) perpendicular to the substrate surface resulted in a uniform coating. SEM of the cross section of the sample revealed large zinc oxide boulders on top of a dendritic zinc oxide nanostructure consisting of columnar assemblies of agglomerated zinc oxide particles of approximately 100 nm in size. The overall thickness of the film was 3.5 microns. XRD revealed that the top of the film consisted of high purity, polycrystalline zincite (ZnO). XPS also indicates a Zn:O ratio of 1:1 the surface and an atomic ratio of Zn:O::2:3 with no carbon contamination in the bulk of the film.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes.

### EQUIVALENTS

The representative examples are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples herein and the references to the scientific and patent literature cited herein. The examples contain important additional information, exemplification and guidance which can be adapted to the practice of this invention in its various embodiments and equivalents thereof.

What is claimed is:

1. A method for producing a structure of a metal or metal oxide, the method comprising:
providing a high-pressure mixture comprising a precursor to a metal or metal oxide and a precursor medium as solvent or solute;
causing a rapid expansion of the high-pressure mixture so as to produce an ultra fine aerosol mist of the precursor to the metal or metal oxide and the precursor medium;
delivering the ultra fine aerosol mist to a flame jet directed at a substrate; and
causing the precursor to the metal or metal oxide to convert into the metal or metal oxide thereby depositing on the substrate a nanostructure comprising the metal or metal oxide.

2. The method of claim 1, wherein the flame jet is a plasma jet.

3. The method of claim 1, wherein the nanostructure is amorphous.

4. The method of claim 1, wherein the nanostructure is crystalline.

5. The method of claim 1, wherein the nanostructure is polycrystalline.

6. The method of claim 1, wherein the metal or metal oxide is in a crystalline state prior to deposition on the substrate.

7. The method of claim 1, wherein the high pressure mixture further comprises an additive capable of modifying a crystalline habit.

8. The method of claim 1, wherein the structure displays a nanostructure.

9. The method of claim 1, wherein the metal is, or the metal oxide is the oxide of a metal, selected from the group consisting of: Ti, Zn, Cu, Ni, Pd, W, Sn, Nb, Au, Co, Ir, Rh, Ru, Pt, Ce, and Yt.

10. The method of claim 9, wherein the metal oxide is TiO₂.

11-13. (canceled)

14. The method of claim 1, wherein the precursor solvent is CO₂.

15. The method of claim 1, wherein the volume percentage of the metal or metal oxide in the high pressure mixture is from about 30% to about 90% .

16-18. (canceled)

19. The method of claim 1, wherein the high-pressure mixture further comprises an organic solvent.

20. The method of claim 19, wherein the high-pressure mixture exists in two phases.

21. The method of claim 19, wherein the high-pressure mixture exists in a single phase.

22. (canceled)

23. The method of claim 1, wherein the high-pressure mixture is in a supercritical state.

24. The method of claim 1, wherein the high-pressure mixture is in a near-supercritical state.

25. A metal or metal oxide nanostructure produced by the process of:
providing a high-pressure mixture comprising a precursor to a metal or metal oxide and a precursor medium as solvent or solute;
causing a rapid expansion of the high-pressure mixture so as to produce an ultra fine aerosol mist of the precursor to the metal or metal oxide and the precursor medium;
delivering the ultra fine aerosol mist to a flame jet directed at a substrate; and
causing the precursor to the metal or metal oxide to convert into the metal or metal oxide thereby depositing on the substrate a nanostructure comprising the metal or metal oxide.

26-57. (canceled)

58. A method for producing a metal or metal oxide thin film, the method comprising:
providing a high-pressure mixture comprising a precursor to a metal or metal oxide and a precursor medium as solvent or solute;
causing a rapid expansion of the high-pressure mixture so as to produce an ultra fine aerosol mist of the precursor to the metal or metal oxide and the precursor medium;
delivering the ultra fine aerosol mist to a flame jet directed at a substrate; and
causing the precursor to the metal or metal oxide to convert into the metal or metal oxide thereby depositing a thin film of the metal oxide on the substrate.

59-63. (canceled)

64. A method for producing a nanostructure of a material comprising a chemical compound, the method comprising:
providing a high-pressure mixture comprising a precursor to the chemical compound and a precursor medium;
causing a rapid expansion of the high-pressure mixture so as to produce an ultra fine aerosol mist of the precursor to the compound and the precursor medium;
delivering the ultra fine aerosol mist to a plasma jet directed at a substrate;
causing the precursor to the compound to convert into the compound via a chemical reaction; and
depositing a nanostructure comprising the compound on the substrate.

65. (canceled)
